(19) United States
(12) Patent Application Publication
(10) Pub. No.: US 2006/0222732 A1
(43) Pub. Date: Oct. 5, 2006

(54) Four-level spruebar-less melt distribution system

(75) Inventor: Antonio Morrone, Woodbridge (CA)

Correspondence Address: MARK R. WISNER;WISNER & ASSOCIATES, Suite 400, 1177 West Loop South, Houston, TX, 77027-9012, US

(73) Assignee: Stackteck Systems Limited, Ontario (CA)

(21) Appl. No.: 10/464,405

(22) Filed: Jun. 18, 2003

(30) Foreign Application Priority Data
Mar. 19, 2003 (CA) 2,422,988

(51) Int. Cl. B29C 35/00

(52) U.S. Cl. 425/572

(57) ABSTRACT

A melt distribution system for a four-level stack mould which avoids the use of a central spruebar extending axially along the moulds. The melt distribution system incorporates leg manifolds for registering with an injection machine nozzle to divert melt radially outwardly from the injection machine nozzle. A first conduit extends from the leg manifold parallel to but axially spaced apart from a mould axis to a central distribution block. Melt is bifurcated in the central distribution block to respective crossover conduits extending from opposite sides of the central distribution block. The crossover conduits are generally parallel to but spaced apart from a mould axis. The crossover conduits fluidly communicate with first and second main manifolds in which melt flow is directed to respective injection nozzles.

### FIELD OF THE INVENTION

This invention relates to melt distribution in plastic injection moulding apparatus. More particularly this invention relates to melt distribution in stack moulds having four levels.

### BACKGROUND OF THE INVENTION

Four-level moulds have been in existence for many years. A typical four-level “stacked” mould (also referred to as a “stack” mould) is illustrated and described in U.S. Pat. No. 5,229,145. Melt is distributed to each level from an injection machine nozzle by a “melt distribution” or “melt transfer” system.

Injection machines are configured to accept a variety of moulds and mould configurations, both single and multiple level. Accordingly the location of the injection machine nozzle is conventionally centralized along a machine axis and moulds are designed with a melt inlet generally axially aligned with a mould axis which corresponds to the machine axis when the mould is mounted.

The conventional arrangement for transferring melt in a four-level mould is, as illustrated in U.S. Pat. No. 5,229,145, uses a spruebar extending from the injection machine nozzle, along the mould axis and through a first two of the four levels to a flow distribution block at the centre of the mould stack. Melt is transferred radially outwardly by the flow distribution block to melt passages that are parallel to but axially offset from the mould axis and then radially inwardly to respective injection moulding nozzles.

The conventional system is only workable where sufficient space exists along the mould axis for a spruebar. However, for large parts which require the moulds in each level to extend across the mould axis, the spruebar cannot extend along the mould axis. Accordingly, the spruebar would ideally have to be located elsewhere, however, because the spruebar is designed to transfer melt straight from the injection machine nozzle, it can't be moved from the central mould axis.

It is an object of the present invention to provide a melt distribution system for a four-level stack mould in which melt is transferred to each level without a central spruebar thereby freeing the mould axis for the moulding of parts.

### SUMMARY OF THE INVENTION

A melt distribution system is provided for a four-level stack mould having first, second, third and fourth mould levels arranged in a stack along the mould axis with the first and fourth levels at opposite ends of the stack, the second level disposed adjacent the first level and the third level disposed between the second and fourth levels. The mould further has a first main manifold disposed between the first and second mould levels for directing melt thereto a second main manifold disposed between the third and fourth mould levels for directing melt thereto and a central distribution block disposed between the second and third mould levels for directing melt to the first and second main manifolds. The melt distribution system has at least one leg manifold having a melt inlet at the mould axis for receiving melt from a machine nozzle of an injection moulding machine, a melt outlet radially offset from the melt inlet and a melt passage providing fluid communication between the melt inlet and the melt outlet. A respective distribution block crossover conduit is associated with each leg manifold and extends generally parallel to but offset from the mould axis between the leg manifold and the central distribution block to provide fluid communication therebetween. A first main manifold crossover conduit extends generally parallel to but offset from the mould axis between the central distribution block and the first main manifolds to provide fluid communication therebetween. A second main manifold crossover conduit extends generally parallel to but offset from the mould axis between the central distribution block in the second main manifolds to provide fluid communication therebetween. Each leg manifold fluidly communicates through the central distribution block with at least one of the first and second main manifold crossover conduits.

The melt distribution system may have first and second leg manifolds sharing a common inlet and diverging therefrom. A first distribution block crossover conduit may be associated with the first leg manifold. A second distribution block crossover conduit may be associated with the second leg manifold. The first main crossover conduit may fluidly communicate through the central distribution block with the first distribution block crossover conduit. The second main crossover conduit may fluidly communicate through the central distribution block with the second distribution block crossover conduit.

The first and second main manifold crossover conduits may incorporate a valveless melt transfer system (“VMTS”) allowing separation along respective lengths thereof. The distribution block crossover conduit may also incorporate a respective VMTS allowing separation along its length. Preferably the VMTS's are laterally offset to avoid drool from one falling onto another.

Each distribution block crossover conduit may incorporate a respective VMTS on each side of the first main manifold allowing separation on either side of the first main manifold.

### DESCRIPTION OF DRAWINGS

Preferred embodiments of the present invention are described below with reference to the accompanying illustrations in which:

FIG. 1 is a schematic illustration of a four-level stack mould melt transfer system according to the present invention;

FIG. 2 is a schematic illustration of an alternate embodiment of a melt transfer system according to the present invention;

FIG. 3 is a schematic illustration of a melt flow path through a melt transfer system according to the present invention;

FIG. 4 is a schematic illustration corresponding to FIG. 3 but illustrating an alternate embodiment melt flow path;

FIG. 5 is a schematic illustration corresponding to FIGS. 3 and 4 but illustrating another alternate embodiment melt flow path; and,

FIG. 6 is a schematic illustration corresponding to FIGS. 3, 4 and 5 but illustrating yet another alternate embodiment melt flow path.

### DESCRIPTION OF PREFERRED EMBODIMENTS

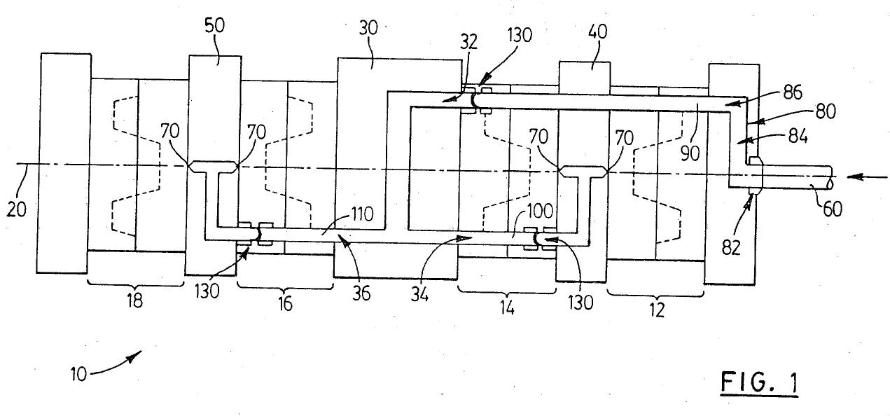

A four-level stack mould incorporating a melt transfer system according to the present invention is generally indicated by reference 10 in FIG. 1. The mould 10 has first, second, third and fourth mould levels 12, 14, 16 and 18 respectively arranged side by side to form a “stack” along a mould axis 20.

The first mould level 12 is at the right side of FIG. 1 and the fourth mould level 18 is at the left side. The second mould level 14 is adjacent the first mould level 12 to the left thereof. The third mould level 16 is between the second mould level 14 and the fourth mould level 18.

A central distribution block 30 is disposed between the second mould level 14 and the third mould level 16. A first main manifold 40 is disposed between said first mould level 12 and said second mould level 14. A second main manifold 50 is disposed between said third mould level 16 and said fourth mould level 18. An injection machine nozzle 60 is shown at the right hand side of FIG. 1 which is axially aligned with the mould axis 20 and provides melt to the stack mould 10.

The conventional melt path for a four-level stack mould would be along the mould axis 20 from the injection machine nozzle 60 to the central distribution block 30 through a spruebar. The central distribution block 30 would then further distribute the melt to the first and second main manifolds 40 and 50 respectively which in turn would distribute the melt to individual nozzles 70.

The present invention avoids having a spruebar extending axially through the first and second mould levels 12 and 14 respectively. This is accomplished by providing a leg manifold 80. The leg manifold has a melt inlet 82 for receiving melt from the injection machine nozzle 60, the leg manifold has a passage 84 which extends radially relative to the mould axis 20 to a melt outlet 86. The passage 84 provides fluid communication between the melt inlet 82 and the melt outlet 86. The leg manifold 80 may be an internal component of a first plate 88.

A conduit 90 extends between the melt outlet 86 of the leg manifold 80 and the central distribution block 30. To differentiate the conduit 90 from other conduits described below it will be referred to as the “distribution block crossover conduit 90” or “distribution crossover 90” for short. The distribution crossover 90 extends generally parallel to but offset from the mould axis 20. It provides fluid communication between the melt outlet 86 of the leg manifold 80 and the central distribution block 30.

The central distribution block 30 has an inlet 32 registering with the distribution crossover 90 for receiving melt therefrom. The central distribution block 30 has a first outlet 34 facing the first main manifold 40 and a second outlet 36 facing the second main manifold 50. According to the FIGS. 1, 2, 3, 5 and 6 embodiments the central distribution block inlet 32 fluidly communicates with both the first outlet 34 and the second outlet 36.

A first main manifold crossover conduit 100 extends and provides fluid communication between the first outlet 34 and the first main manifold 40. A second main manifold crossover conduit 110 extends and provides fluid communication between the second outlet 36 and the second main manifold 50. The first and second main manifolds 40 and 50 respectively receive and distribute melt to the nozzles 70.

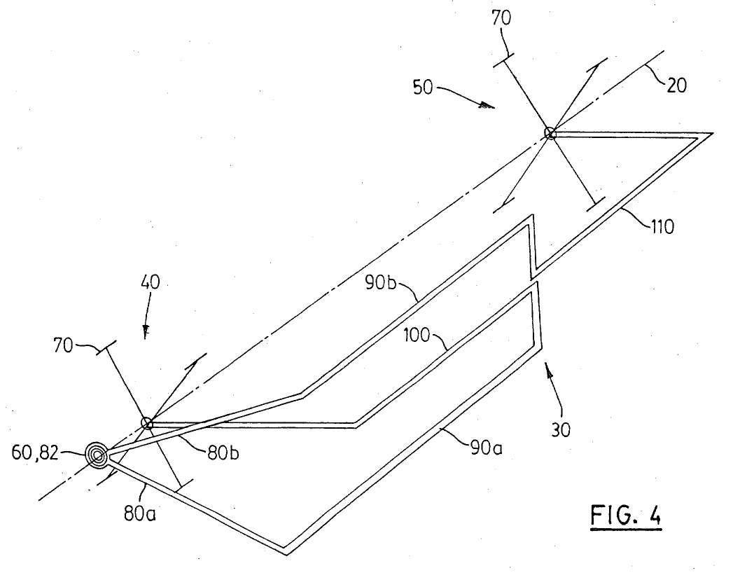

According to the FIG. 4 embodiment, melt is divided into two melt streams at the injection machine nozzle 60 by providing first and second leg manifolds 80a and 80b respectively. The first and second manifolds 80a and 80b have respective distribution crossovers 90a and 90b. In the FIG. 4 embodiment the first main manifold crossover conduit 100 fluidly communicates with the first leg manifold 90a through the central distribution block 30. The second main manifold crossover conduit 110 fluidly communicates with the second manifold 90b through the central distribution block 30.

The mould 10 is illustrated in a “closed” or “moulding” configuration wherein the mould levels are pressed together for the forming of parts 120. In order to remove the parts 120, the mould levels would be moved apart into a spaced apart “open” or “stripping” configuration.

In order to accomplish this each distribution crossover 90 (or 90a and 90b in the FIG. 4 embodiment), and the first and second main manifold crossover conduits 100 and 11 0 respectively are separable along their respective lengths. FIG. 1 illustrates one manner in which this may be accomplished is through the use of a respective valveless melt transfer system (“VMTS”) 130 along each of the distribution crossover 90 (or crossovers 90a and 90b), first main manifold crossover conduit 100 and second main manifold crossover conduit 110. Each VMTS 130 may for example be of the type described in U.S. Pat. No. 5,458,843 entitled “Pin-Less Drool Prevention System”. The specific separation system selected may depend on system parameters such as available space as would be familiar to one skilled injection moulding apparatus.

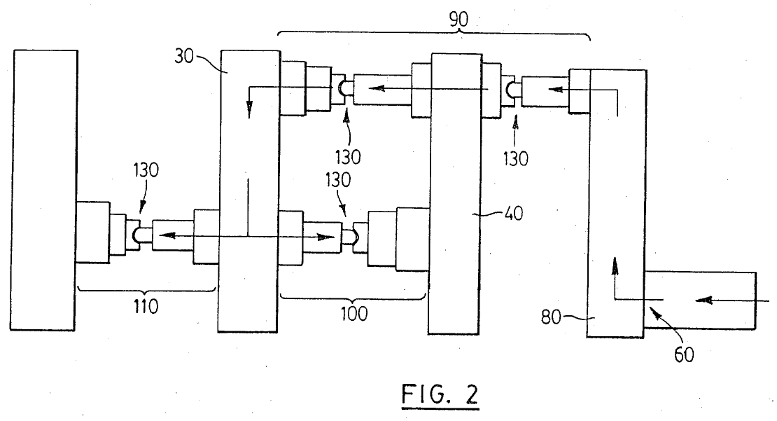

FIG. 2 illustrates an alternate embodiment to FIG. 1 wherein the distribution crossover 30 has two VTMS connectors 130, one on either side of the first main manifold 40. According to the FIG. 2 embodiment, the distribution crossover 90 is separated at the first main manifold 40. This contrasts with the FIG. 1 embodiment in which the second main manifold 40 is slidable relative to the distribution crossover 90. Other separation systems may also be utilized, for example a valve gate system such as described in U.S. Pat. No. 4,212,626 may be used at reference 130 to separate the distribution crossover instead of the VMTS referred to above.

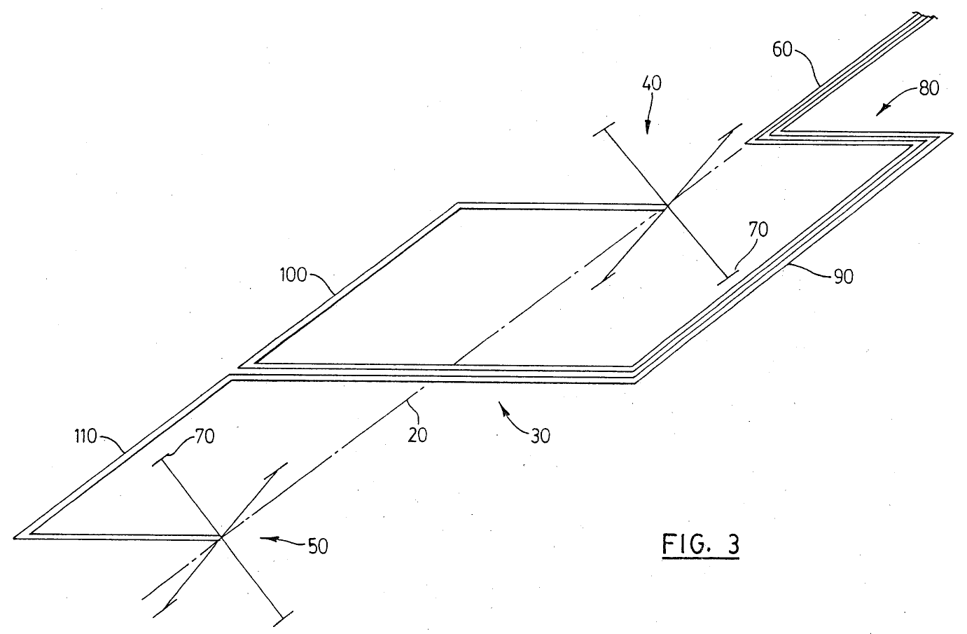

FIGS. 3 through 6 illustrate alternate ways to configure a melt distribution system according to the present invention.

FIG. 4 has been described above.

FIG. 3 illustrates an arrangement wherein the distribution crossover 90 is on an opposite side of the mould axis 20 from the first and second main manifold crossover conduits 100 and 110 respectively.

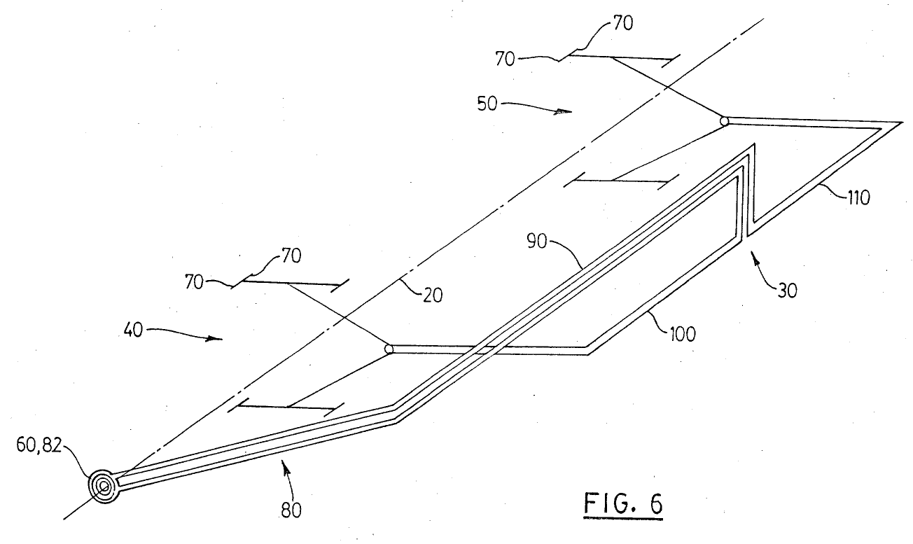

FIG. 6 illustrates an arrangement wherein the distribution crossover 90 is on the same side of the mould axis 20 as the first and second main manifold crossover conduits 100 and 110 respectively. According to the FIG. 6 embodiment the VMTS 130 for the distribution crossover 90 would overlie the VMTS 130 for the first main manifold crossover conduit 100. This might cause some melt to drool from one VMTS 130 onto an underlying VMTS 130.

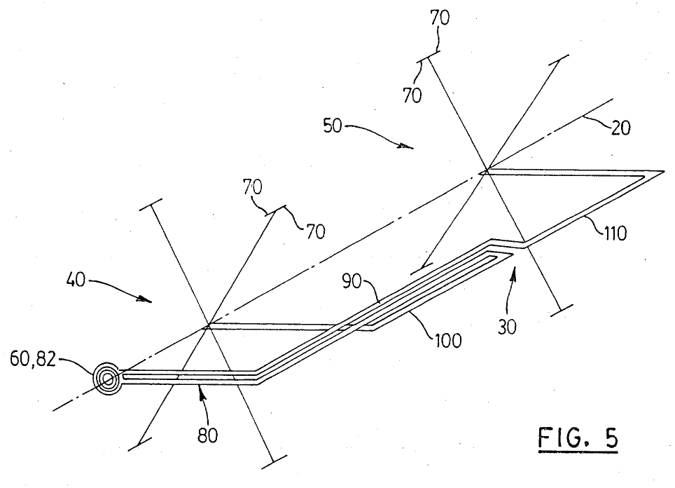

According to the FIG. 5 embodiment, the distribution crossover 90 is on the same side of the mould axis 20 as the first and second main manifold crossover conduits 100 and 110 respectively. Unlike the FIG. 6 embodiment the VMTS connectors 130 are side by side rather than one above the other to avoid drool from one landing on the other.

The above description is intended in an illustrative rather than a restrictive sense. Variations may be apparent to those skilled in the art without departing from the spirit and scope of the invention as defined by the claims set out below.

1. A melt distribution system for a four level stack mould having first, second, third and fourth mould levels arranged in a “stack” along a mould axis with said first and fourth levels at opposite ends of said stack, said second level disposed adjacent said first level and said third level disposed between said second and fourth levels, a first main manifold disposed between said first and second mould levels for directing melt thereto, a second main manifold disposed between said third and fourth mould levels for directing melt thereto and a central distribution block disposed between said second and third mould levels for directing melt to said first and second main manifolds, said melt distribution system comprising:
at least one leg manifold having a melt inlet at said mould axis for receiving melt from a machine nozzle of an injection moulding machine, a melt outlet radially offset from said melt inlet and a melt passage providing fluid communication between said melt inlet and said melt outlet;
a respective distribution block crossover conduit associated with each said at least one leg manifold extending generally parallel to but offset from said mould axis between a respective said leg manifold outlet and said central distribution block to provide fluid communication therebetween;
a first main manifold crossover conduit extending generally parallel to but offset from said mould axis between a respective of said at least one central distribution block and said first main manifold to provide fluid communication therebetween;
a second main manifold crossover conduit extending generally parallel to but offset from said mould axis between said central distribution block and said second main manifold to provide fluid communication therebetween;
said first and second main manifold crossover conduits being located radially outwardly of any parts to be manufactured at each of said first, second, third and fourth mould levels; and
each said at least one leg manifold fluidly communicating through said central distribution block with at least one of said first and second main manifold crossover conduits.

2. The melt distribution system of claim 1 having:
a first and a second of said leg manifolds sharing a common inlet and diverging therefrom;
a second said distribution block crossover conduit associated with said second leg manifold, and wherein,
said first main manifold crossover conduit fluidly communicates through said central distribution block with said first distribution block crossover conduit; and,
said second main manifold crossover conduit fluidly communicates through said central distribution block with said second distribution block crossover conduit.

3. The melt distribution system of claim 1 wherein:
said first and second main manifold crossover conduits each incorporate a VMTS allowing separation along respective lengths thereof, and,
each said distribution block crossover conduit incorporates a respective VMTS allowing separation along respective lengths thereof.

4. The melt distribution system of claim 2 wherein:
said first and second main manifold crossover conduits each incorporate a VMTS allowing separation along respective lengths thereof; and,
each said distribution block crossover conduit incorporates a respective VMTS allowing separation along its length.

5. The melt distribution system of claim 3 wherein:
said VMTS's are laterally offset to avoid drool from one falling onto another.

6. The melt distribution system of claim 3 wherein:
each said distribution block crossover conduit extends through said main manifold and incorporates a separate VMTS on each side of the first main manifold to allow said distribution block crossover conduit to be separated on both sides of said first main manifold.

7. The melt distribution system of claim 4 wherein:
each said first and second distribution block crossover conduit incorporates a separate VMTS on each side of the first main manifold.

8. The melt distribution system of claim 6 wherein:
said VMTS's are laterally offset to avoid drool from one falling onto another.

9. The melt distribution system of claim 7 wherein:
the VMTS's are laterally offset to avoid drool from one falling onto another.

10. The melt distribution system of claim 4 wherein the VMTS's are laterally offset to avoid drool from one falling onto another.

11. The melt distribution system of claim 1 wherein:
said first and second main manifold crossover conduits each incorporate a valve gated melt transfer system allowing separation along respective lengths thereof; and,
each said distribution block crossover conduit incorporates a respective valve gated melt transfer system allowing separation along respective lengths thereof.

12. The melt distribution system of claim 2 wherein:
said first and second main manifold crossover conduits each incorporate a valve gated melt transfer system allowing separation along respective lengths thereof; and,
each said distribution block crossover conduit incorporates a respective valve gated melt transfer system allowing separation along its length.

13. The melt distribution system of claim 3 wherein:
said valve gated melt transfer systems are laterally offset to avoid drool from one falling onto another.

14. The melt distribution system of claim 3 wherein:
each said distribution block crossover conduit extends through said main manifold and incorporates a separate valve gated melt transfer system on each side of the first main manifold to allow said distribution block crossover conduit to be separated on both sides of said first main manifold.

15. The melt distribution system of claim 4 wherein:
each said first and second distribution block crossover conduit incorporates a separate valve gated melt transfer system on each side of the first main manifold.

16. The melt distribution system of claim 6 wherein:
said valve gated melt transfer systems are laterally offset to avoid drool from one falling onto another.

17. The melt distribution system of claim 7 wherein:
the valve gated melt transfer systems are laterally offset to avoid drool from one falling onto another.

18. The melt distribution system of claim 4 wherein the valve gated melt transfer system's are laterally offset to avoid drool from one falling onto another.
